(19) United States
(12) Patent Application Publication
(10) Pub. No.: US 2014/0284249 A1
(43) Pub. Date: Sep. 25, 2014

(54) DISPLAY CAROUSEL WITH INDICIA

(71) Applicant: CAROUSEL AD MASTER, INC., Burnsville, MN (US)

(72) Inventor: Robert Thamert, Burnsville, MN (US)

(21) Appl. No.: 14/224,647

(22) Filed: Mar. 25, 2014

Related U.S. Application Data
(60) Provisional application No. 61/805,000, filed on Mar. 25, 2013.

(51) Int. Cl. A47F 7/14; G06Q 90/00

(52) U.S. Cl. CPC A47F 7/145; G06Q 90/00
USPC 206/740; 705/500

(57) ABSTRACT

Various embodiments of rotating display carousels, such as for newspapers, magazines, brochures, etc. are provided with indicia by way of indicia exhibiting elements, such as for advertising, on at least one side thereof. The advertising may be printed or may be electronic. Preferably, the advertising is removable and replaceable on the carousel, allowing for updating, changing and/or rotating of select advertising. An aspect of managing the use of such a carousel is to provide such advertising onto such display carousels, preferably as such advertising relates to a business that is not of the business within which such a display carousel is to be placed. Such advertising may be provided in the form of a sheet of paper or polymeric material with indicia or advertisement print on a display surface along with an adhesive, or other connection system, such as including mechanical devices, magnetic material, hook and loop fasteners, or other fastening or bonding system.

### CROSS-REFERENCE TO RELATED APPLICATIONS

This application claims the benefit of U.S. Provisional Patent Application No. 61/805,000, filed Mar. 25, 2013 and titled “DISPLAY CAROUSEL WITH INDICIA” which application is incorporated herein by reference in its entirety.

### BACKGROUND

It is common with office reception or waiting room areas for the related business to supply reading materials for patrons. Such materials typically include newspapers, magazines, and the like for the patrons to peruse while they are waiting for an appointment or availability of a business service person. Office reception or waiting areas are common for professional services such as medical offices, dental offices, clinics, hospitals, law firms, banks, real estate offices, mortgage and title companies, and the like. Also, service departments, such as at car service or repair establishments, electronics services, and the like often provide waiting areas for customers to relax while such services are being performed.

Reading materials are usually set out such as on tables, desks, chairs, or the like or are provided within a rack structure for displaying the magazines, newspapers etc, to be selected by a patron. Magazine and newspaper racks are well known for positioning such materials to be partially viewed by a patron and from which any such reading material can be selected by the patron. Racks are also well known as being floor or wall supported.

Businesses with such reception and waiting areas also commonly provide promotional materials related to the subject business for patrons to peruse while waiting. For example, medical or dental offices might set out pamphlets that provide information related to optional medical or dental procedures. The same can be true for optional services for other professional or other service type establishments. Such promotional materials are thus targeted to the patrons of the business for services that are also related to the subject business.

### SUMMARY

The present disclosure is directed to various embodiments of rotating display carousels, such as for newspapers, magazines, brochures, etc. that also include indicia, such as advertising, on at least one side thereof. The advertising may be printed or may be electronic. Preferably, the advertising is removable and replaceable on the carousel, allowing for updating, changing and/or rotating of select advertising.

It is also a preferable aspect of the present invention to provide such advertising onto such display carousels as such advertising relates to a business that is not of the business within which such a display carousel is to be placed. Such advertising may be provided in the form of a sheet of paper or polymeric material with indicia or advertisement print on a display surface along with an adhesive, or other connection system, such as including mechanical devices, magnetic material, hook and loop fasteners, or other fastening or bonding system. Where an adhesive is utilized for locating the advertisement to the carousel, it is preferable that a low tack or removable adhesive be used so that the advertisement can be easily changed by peeling off an old advertisement and replacing it with a new one.

In another aspect of the present invention related to the provision of advertisement onto a display carousel, such advertisement can preferably also be provided with any number or combinations of bar codes, linear bar codes or two-dimensional bar codes like a Quick Response or QR code, or text messaging key words and numbers, so that patrons have the ability to gain more information based upon the advertisement. Such provision of further information may be managed along with a service of controlling the advertisement content as displayed on each carousel, which control can be managed on a location, business, or other relevant category basis.

It is yet another aspect of the present invention to provide an organizational solution to reading materials as may be displayed for viewing by patrons at a business location. Reading materials may include periodicals such as magazines and newspapers as well as brochures or forms or the like that are related to the subject business. Preferably, such organization solutions can include specifically sized display slots or pockets for certain size materials while also sizing other display pockets for other size materials. More preferably, the display carousel can be transparent or translucent so that portions of the reading materials can be viewed through the carousel structure while a tiered structure also displays such materials in a way to be easily browsed by a patron. With organized display pockets of sizes that directly relate to certain sized reading materials, not only is it easy to select which type material goes in to which pocket, patrons will find it easier to return materials to the pocket from which they were taken.

Various forms of the present invention are contemplated based upon different types of reading materials that might be displayed. Such carousels can be tailored based upon one or more specific type of business or may be of a generalized nature. Businesses that utilize and wish to display forms, for example, to patrons will select a carousel with display pockets related to the sizing of the typical forms presented. A general purpose carousel may include typical pocket sizes to accommodate newspapers and periodicals as such are typically provided of a certain known size.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawing, in which:

FIG. 1 shows a first embodiment of a display carousel according to the present invention that is positioned for use including an organized selection of reading materials provided in a tiered fashion and including examples of advertisements as located on plural external surfaces of the carousel.

FIG. 2 shows a carousel similar to that of FIG. 1, but without indicia or any advertisements on the external surfaces after being removed such as for replacement.

FIG. 3 shows an embodiment of a display carousel according to the present invention including multiple tiered material pockets or slots for receiving and displaying such reading materials in an organized manner and which can be easily viewed by a patron of an establishment.

FIG. 4 shows another embodiment of a display carousel according to the present invention with a configuration to accommodate differently shaped materials as that of FIG. 3 and with less pockets defined by plural tiers.

FIG. 5 shows another embodiment of a display carousel according to the present invention with a configuration to accommodate differently shaped materials as that of FIG. 3 or 4 and with multiple tiered pockets and peripheral pockets.

FIG. 6 shows yet another embodiment of a display carousel according to the present invention with a configuration to accommodate differently shaped materials as that of FIGS. 3, 4 and 5 with multiple tiered pockets and peripheral pockets with a side-to-side configuration.

### DETAILED DESCRIPTION

The present invention is directed to rotating display carousels, such as display carousels for newspapers, magazines, brochures, and other similar reading materials. Such display carousels are usable in or waiting or reception areas, such as those with high turn-over, such as waiting or reception rooms for professional services such as medical offices, dental offices, clinics, hospitals, law firms, banks, real estate offices, mortgage and title companies, and the like. Also, service departments, such as at car service or repair establishments, electronics services, and the like often provide waiting areas for customers to relax while such services are being performed. for doctors' offices, dentists' offices, etc.

In the following description, reference is made to the accompanying drawings that form a part hereof and in which are shown by way of illustration a plurality of specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower”, “upper”, “beneath”, “below”, “above”, “on top”, etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above those other elements.

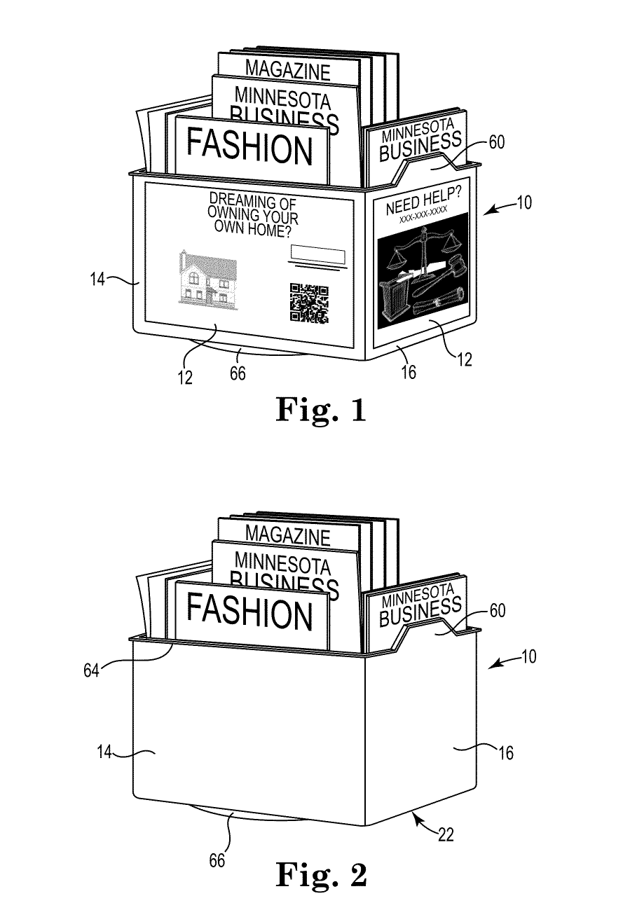

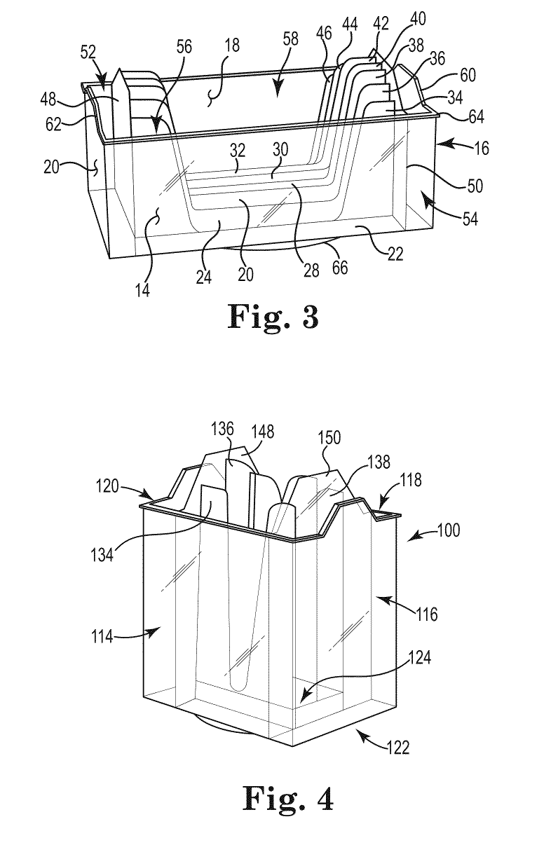

Referring to FIG. 1 and FIG. 2, a rotatable display carousel 10, having an indicia exhibiting element 12 with advertising on at least one side, is shown. In FIG. 1, the carousel 10 has an indicia exhibiting element 12 on at least two sides (as visible), although preferably the carousel has indicia on all sides. Although the carousel models illustrated in FIGS. 1 and 2 and also in FIGS. 3 through 6 are rectangular, four-sided carousels, it is understood that carousels with fewer (e.g., 3 sides) or more (e.g., 5 sides, 6 sides, etc.) could be fitted with advertising indicia in accordance with this disclosure. Any number of sides can be utilized for advertising indicia, or any side can be without indicia as well depending on any particular use.

FIG. 2 shows the carousel 10 without indicia and FIG. 3 shows the carousel 10 as being transparent or translucent and comprising an open-top receptacle including a front side 14, and first side 16, and back side 18 and second side 20. The carousel 10 further comprises a bottom 22 that is preferably tiered so as to provide different stepped support levels for reading material to be displayed within the carousel 10. As shown, bottom tier surfaces 24, 26, 28, 30 and 32 are illustrated to provide plural levels above the surface of bottom 22 for supporting reading materials at different heights, as is illustrated within FIGS. 1 and 2. Divider vanes 34, 36, 38, 40, 42, 44, and 46 are preferably also provided to correspond with the number of bottom tier surface so as to define a like plurality of pockets for receiving such reading materials. The vanes 34, 36, 38, 40, 42, 44, and 46 are preferably provided at spaced positions on each side of the bottom ties surfaces 24, 26, 28, 30, and 32 so as to define the pockets. More preferably, the vanes 34, 36, 38, 40, 42, 44, and 46 extend from side wall portions 48 and 50, which themselves are preferably spaced from the sides 20 and 16, respectively to further define sides pockets 52 and 54. Pockets 52 and 54, like front pocket 56 and rear pocket 58 are shown as having bottom portions that are at the lowest level of the bottom 22 as a peripheral bottom surface portion that is divided by the side wall portions 48 and 50. The divided pockets formed by the vanes 34, 36, 38, 40, 42, 44, and 46 and the bottom stepped tier surfaces 24, 26, 28, 30, and 32 provided a series of pockets that preferably get higher to the central portion of the carousel 10 so as to display materials of a common general shape in a stepped fashion as shown in FIGS. 1 and 2. Materials displayed around the perimeter are supported at the same lower level, but in the illustrated embodiment, the end pockets 52 and 54 display smaller width materials than the front and rear pockets 56 and 58 based upon the dimensions of the front 14, back 18, and the sides 16 and 20. It is contemplated that additional dividers can be incorporated within designs of the present invention, for example, to divide a front pocket 56 into plural smaller width pockets.

It is contemplated that any number of pockets can be defined with structures of the present invention. It is preferably that at least one bottom surface portion is stepped or tiered to be higher than at least one other bottom panel to provide plural pockets of different heights so that similar sized materials, for example, magazines of standard magazine size, will be displayed at different heights to make it easier for a patron to peruse the materials distinctly from one another. It is also preferable that the perimeter pockets be lower than the more central pockets to provide a stepped display that more preferably includes multiple steps of increased height as compared to the lowest level of bottom 22. Plural pockets at the most central position may be of the same height providing the same viewing level from opposite sides of the carousel 10. Pocket designs may favor front and rear pockets positions as shown in FIGS. 1-3, providing multiple stepped pockets from front to rear with just two side pockets 52 and 54. Other designs may favor a side to side orientation. It is also contemplated that both side to side and front to rear orientations can be designed with stepped bottom portions stepping low to high preferably in both orientations.

Pocket designs also preferably take in account the material that is expected to be displayed by a particular carousel design. Newspapers, for example, would preferably be accommodated by wide pockets, for example, pockets 56 and 58, while pockets such as those defined by the vanes 34, 36, 38, 40, 42, 44, and 46 could be of a common magazine width. The side pockets 52 and 54 could be sized of magazine size or for other promotion materials of any size.

Carousels 10 of the present invention also preferably include handle portions 60 and 62. The top perimeter of the carousel is also preferably provided with a perpendicular portion or flange 64 that allows for easier grabbing of the carousel whether for rotating or lifting the carousel 10 as desired.

The carousel 10 is preferably rotatable, more preferably over 360 degrees, to allow all sides of the display to be viewed from a single location by the viewer. Rotary support 66 is illustrated from which the carousel 10 is rotatably supported. The rotary support can comprise any conventional lazy-susan type device, such as typically including the support 66 having a central axle or pin that also is operatively provided through a portion of the bottom 22 of the carousel 10. Bearing surfaces or balls may be provided to allow for smooth rotation. The carousel may be motorized, to slowly spin on its own, but in most embodiments, the viewer will spin the carousel when desired.

The display carousel may be configured in essentially any shape and size, and be configured with any number of slots for items such as magazines and newspapers. FIGS. 4 through 6 provide detailed designs of four other suitable carousels described in more detail below.

The carousel can be formed from any suitable material, such as plastic (polymer), metal, paperboard or pressboard, composite, or any other material. Plastic carousels are preferable in that they can be injection molded as a single structure or they can easily be made up of and formed from multiple molded structures. The carousel may be opaque, transparent, or partially or wholly translucent.

In FIG. 4, a second embodiment of a rotary carousel 100 is illustrated having similar features as that of FIGS. 1-3 but with different dimensions, aspect ratios and pocket designs. The design of carousel 100 includes a front wall 114, a rear wall 118, and sides 116 and 120. A bottom 122 is lowest around the perimeter of the carousel 100 with a single stepped-up level provided by a bottom tier portion 124. That bottom tier portion 124 is bounded and once divided by vanes 134, 136, and 138 to define to central pockets bounded on four sides by front, rear, and two side pockets. Wall portions 148 and 150 divide the lower level perimeter into the four pockets and provide positional support for the vanes 134, 136, and 138. This design may be suitable for magazines or for promotional material, such as service or product pamphlets or brochures of different sizes. The aspect ratio of the design of the FIG. 4 carousel 100 suggests it is designed for materials that are longer vertically versus their width as compared with the newspapers and magazines of the FIGS. 1-3 carousel 10

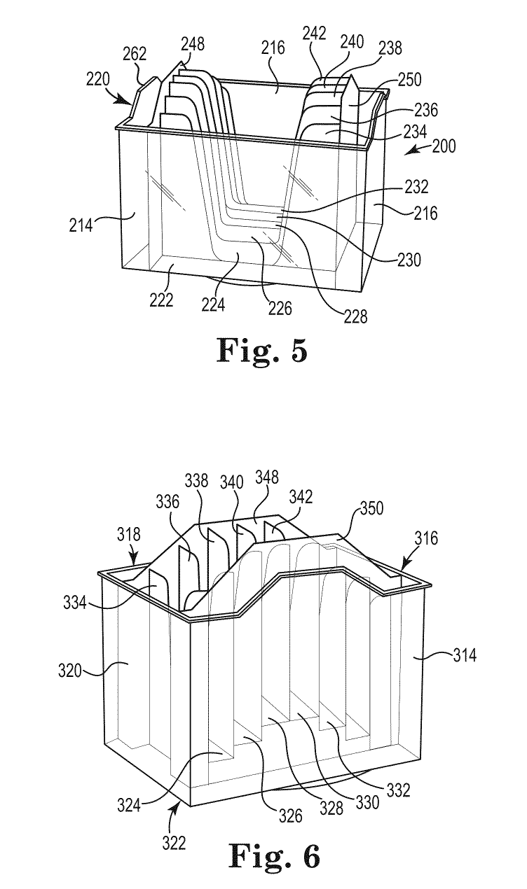

FIG. 5 shows another embodiment of the present invention for a rotary carousel 200 that is similar to FIGS. 1-3 but with distinctly different aspect ratios in length to height, in particular. Elements of similar description as above with respect to FIGS. 1-3 are similarly labeled within FIG. 5 but preceded with a 2 in the hundredth position as a distinct separate embodiment. FIG. 6 shows another embodiment of the present invention for a rotary carousel 300 that is also similar to that of FIGS. 1-3 but with different aspect ratios in many aspects and with a predominantly side-to-side orientation or pocket layout design. Elements of similar description as above with respect to FIGS. 1-3 are similarly labeled within FIG. 6 but preceded with a 3 in the hundredth position as a distinct separate embodiment.

The carousels 10, 100, 200 and 300 are illustrated as transparent and without indicia or advertisement in order to clearly illustrate pocket and carousel designs of the present invention as examples. As above, any and all external surfaces provide surfaces that may be utilized for placement of indicia such as advertisements in accordance with the present invention. Plural ads can be provided to any one surface as well.

The indicia may be any design or text desired. In most embodiments, the indicia will be advertising, for example, advertising for a store, a real estate broker or agent, a radio station, a service (e.g., plumber, electrician). The advertising may be long-term, directed to the existence of a store or service, or may be short-term, directed to announcing a sale or new product, or an up-coming community event.

According to as aspect of the present invention, the placement of advertisements to the carousels 10 as well as the placement of the carousels themselves can be managed so as to increase effectiveness. Display carousels with indicia can be displayed at hundreds of possible locations, including dentists' offices, doctors' offices, hair salons, nail salons, veterinary clinics or offices, chiropractors' offices, auto repair shops and auto dealers, car washes, fitness centers, tanning salons, and other locations where people will be waiting, for example, for at least 3 to 5 minutes, although the waits are typically much longer. The indicia on the display carousel can be focused on and pinpointed to the persons who are likely to view the indicia at the location; this focusing may be based on income, lifestyle, geography, ethnic background, etc. Additionally, the indicia on the display can be managed based upon the desire of the advertiser so as to control the location; for example, a Ford dealer can ban any advertising for Toyota or other car company. Target audiences being matched with specific advertisement as managed is a significant advantage of the present invention. The carousels of the present invention provide a focused advertisement vehicle that can be placed for target audiences. The advertisements are also preferably changeable as described below to enhance this advantage. In addition to providing a focused advertisement vehicle, the carousels of the present invention, as described above cleans up the clutter of reading materials spread around a reception or waiting area and presents such reading materials for easy perusal by patrons of a business. A managed program of the present invention includes the matching of focused target audiences with advertisement.

The types of business that could advertise their business or services on a display carousel with indicia include realtors and real estate agents and brokers, attorneys, cosmetic surgeons, dentists, chiropractors, apartment complexes and other real estate rental businesses, mortgage brokers, banks, bridal shops, restaurants, labor recruitment companies, casinos, cellular phone stores and/or providers, radio stations, TV stations, lotteries, appliance stores, department stores, pharmacies, and internet and computer companies and servicers. Non-commercial groups such as Boy Scouts, 4-H, FFA, etc. could advertise upcoming events, animal shelters could advertise available animals, and law enforcement could advertise ‘most wanted’ lists. In accordance with an aspect of the present invention, advertisements are preferably not of the subject business (where the carousel is located), although they could be, but are for other business that can benefit from having their ads placed at a specific target audience location. Management of such a service is also an aspect of the present invention.

As shown in FIG. 1, the advertising may include a QR (quick response) code, to allow viewers with an enabled ‘smart phone’ or other device to obtain additional information about the product or service being advertised. Similarly, an ad may include a text message key word and number that a patron can send to receive additional information related to the ad placed on the carousel. With both or either of the QR code or text keyword, it is also an aspect of the present invention to manage and property associate additional related information to the product or serviced of the ad. A service can be provided by a manager to provide, control and change ads based upon client desires and the matching of focused ads with target groups as above. This same manager can also offer to include a QR code and/or text keyword and to control and provide the additional information. The use of codes and keywords can advantageously be easily tracked by the manager so as to provide feedback to a client regarding the effectiveness of an advertising campaign. Such an advertising campaign allows for easy changing of ads, target groups, and additional relevant information.

The indicia may be printed (for example, on paper or a polymeric substrate) or may be electronic.

Printed advertisements may be permanently attached to the display carousel, for example with a permanent adhesive, but preferably are attached to the display carousel in a manner that is easily removed. For example, an easy-peel or other low-tack adhesive may be used to adhere the advertisement to the carousel. Low-tack adhesives are commercially available and usable in accordance with the present invention. Alternately, the display carousel may be fitted with tabs, slots, clips, sleeves or other features to allow the advertisement (printed on a sturdy base) to be slid into or clipped on the carousel. It is also contemplated that magnetic materials can be utilized, such as using flexible magnets as can be secured to a magnetic material like a metal. Printed advertisements may be changed or updated every, for example, 1 week, 2 weeks, 1 month, depending on the advertisement and/or depending on the flow of traffic through the area where the display carousel is located. For example, dentist offices may update the advertisements every 6 months, whereas locations with more frequent visitors, such as fitness centers and health clubs, may update every week. An advantage of the present invention is that the carousels and the ad themselves are easily changeable allowing for quick and easy ad management. If codes or keywords are used as described above, feedback data can influence ad management as well.

With electronic displays, the display can be configured to show one advertisement or can be configured to circle through multiple advertisements, leaving each one up for, for example, 2 minutes. Of course this can be adjusted depending on the amount of information provided in the advertisement. Updating and changing the advertisement is particularly easy with an electronic display. The electronic display monitor can be programmed to power down or hibernate at times when no viewer traffic is expected, such as after 6:00 pm in a doctor's office.

An electronic display can comprise small LED type screens as are commonly used within smart phones, tablets and small electronic devices. The screens can be chosen to fit certain carousel designs, as discussed above. A power source would be provided either within the screen structure itself or could be externally provided, such as including one or more batteries that could be positioned internally of the carousel structure. Alternatively, a power cord can be provided to one or more screens of a carousel and such power cord can extend from a carousel design to be plugged in at a location of the carousel.

Also with electronic displays, the display can be programmed and controlled from a remote location, for example, from a computer in an office building several miles away, or by a ‘smart phone’ several hundred miles away. This remote control of the electronic display may be done by any module, such as internet WiFi, LAN, BlueTooth, ZigBee, CDMA/GSA, and the like.

Any electronic display monitor is preferably removable from the display carousel, for example, for cleaning, repairing or replacing damaged displays, replacing batteries, and as display technology improves. The carousel can be designed with a LED type screen incorporated within any external wall design. Ot, the display carousel may be fitted with tabs, slots, clips or any other feature to allow the electronic display screen to be mounted on any external surface of the carousel.

Thus, numerous embodiments of the DISPLAY CAROUSEL WITH INDICIA are disclosed. The implementations described above and other implementations are within the scope of the following claims. One skilled in the art will appreciate that the present invention can be practiced with embodiments other than those disclosed. The disclosed embodiments are presented for purposes of illustration and not limitation.

What is claimed is:

1. A display carousel for organizing and displaying various forms of reading material and for focused advertising, the display carousel comprising a receptacle operatively mounted for rotation to a support base, the receptacle having an open top and a bottom along with a plurality of side walls defining the receptacle, the side walls having external surfaces and the bottom having a plurality of tiered surfaces at different heights so as to support reading materials at different heights for a tiered display of the reading materials, the carousel further including a plurality of indicia exhibiting elements that are removably provided to a plurality of the external surfaces of the side walls.

2. The display carousel of claim 1, wherein the tiered bottom surfaces provide higher tiered surface toward a central portion of the receptacle.

3. The display carousel of claim 2, wherein plural peripheral pockets are provided around the periphery of the receptacle with each of the plural peripheral pockets at a same height relative to one another but divided from one another by plural wall portions.

4. The display carousel of claim 3, wherein the bottom tiered surfaces provide multiple stepped surfaces in one direction from one side of the carousel stepping higher to the central portion of the receptacle followed by multiple stepped surfaces in the same direction lower than one another toward from the higher central portion.

5. The display carousel of claim 4, wherein pockets are defined by the bottom tiered surfaces along with divider vanes associated with each bottom tiered surface and extending from the bottom.

6. The display carousel of claim 1, wherein the indicia exhibiting elements are removably secured to external surfaces by way of a low-tack adhesive.

7. The display carousel of claim 6, wherein the indicia exhibiting elements comprise a substrate with advertisement printing on a surface thereof on an opposite surface from a surface provided with the low-tack adhesive.

8. The display carousel of claim 7, wherein the indicia exhibiting elements also comprise at least one of a two-dimensional bar code and a keyword that are readable and/or can be utilized to gain additional information related to the indicia that is exhibited on at least one indicia exhibiting element.

9. The display carousel of claim 1, wherein the indicia exhibiting elements are removably secured to the external surfaces by utilizing flexible magnetic material within the indicia exhibiting elements.

10. A method of managing display carousels, each carousel provided for organizing and displaying various forms of reading material and for focused advertising, the display carousel comprising a receptacle operatively mounted for rotation to a support base, the receptacle having an open top and a bottom along with a plurality of side walls defining the receptacle, the side walls having external surfaces and the bottom having a plurality of tiered surfaces at different heights so as to support reading materials at different heights for a tiered display of the reading materials, the carousel further including a plurality of indicia exhibiting elements that are removably provided to a plurality of the external surfaces of the side walls, the method of managing comprising the steps of:
removably securing and thus providing focused advertising on the plurality of indicia exhibiting elements of a display carousel; and
positioning the display carousel at a select location with an expectation of a specific target audience based upon a business of the select location.

11. The method of claim 10 further comprising the step of removing the focused advertising by removing at least one of the plurality of indicia exhibiting elements of the display carousel and securing a different indicia exhibiting element in its place.

12. The method of clam 11, wherein the removing step comprising peeling the indicia exhibiting element from an external surface of a side wall of the display carousel so as release adhesion of a low-tack adhesive.

13. The method of claim 10, wherein the indicia exhibiting elements include at least one of a two-dimensional bar code and a keyword that are readable and/or can be utilized to gain additional information related to the indicia that is exhibited on at least one indicia exhibiting element, and the managing of the carousels includes providing additional information to a patron in response to a request by way of such bar code or keyword.

14. The method of claim 10, wherein the managing of the display carousels also comprises focusing the indicia provided to the plural indicia exhibiting elements to business that is not a business of the location within which the display carousel is positioned.

15. The method of claim 14, wherein the managing of the display carousels also includes selecting business advertisements for display by the plural indicia exhibiting elements based upon the business of the location within which the display carousel is positioned.
